(19) United States
(12) Patent Application Publication
(10) Pub. No.: US 2008/0295631 A1
(43) Pub. Date: Dec. 4, 2008

(54) DRIVEN COMPONENT OF A PRINTING PRESS

(75) Inventors: Peter KNAUER, Muenster (DE); Arthur Meitinger, Zusmarshausen (DE); Josef Singler, Binswangen (DE)

Correspondence Address: CROWELL & MORING LLP;INTELLECTUAL PROPERTY GROUP, P.O. BOX 14300, WASHINGTON, DC, 20044-4300, US

(73) Assignee: manroland AG, Offenbach/Main (DE)

(21) Appl. No.: 12/130,697

(22) Filed: May 30, 2008

(30) Foreign Application Priority Data
Jun. 1, 2007 (DE) 10 2007 025 752.1

(51) Int. Cl. F16H 55/17

(52) U.S. Cl. 74/434

(57) ABSTRACT

A driven component, in particular a printing couple or folding unit, of a printing press, having several rotating elements, in particular cylinders or rollers, wherein at least two rotating elements are assigned to intermeshing drive gears, is disclosed. The drive gear of a first rotating element, which meshes with the drive gear of a second rotating element, is assigned a co-rotating gear, which is connected to the drive gear of the first rotating element via at least one spring element or bending element, which extends in the axial direction of the first rotating element. The co-rotating gear can be rotated with respect to the drive gear in such a way in the circumferential direction that a meshing between the two intermeshing drive gears that is affected in principle by backlash can be kept free of backlash.

This application claims the priority of German Patent Document No. 10 2007 025 752.1, filed Jun. 1, 2007, the disclosure of which is expressly incorporated by reference herein.

### BACKGROUND AND SUMMARY OF THE INVENTION

The invention relates to a driven component, in particular a printing couple or a folding unit, of a printing press.

Printing units of web-fed printing presses known from practice have several printing couples, wherein each printing couple features a transfer cylinder, a plate cylinder, an inking system as well as a dampening unit if applicable. The plate cylinders are also designated as engraving cylinders and transfer cylinders are also designated as blanket cylinders. An impression cylinder cooperates with the transfer cylinder or blanket cylinder of a printing couple forming a nip for the to-be-printed printing substrate, wherein the impression cylinder can be a satellite cylinder or a transfer cylinder and/or blanket cylinder of an adjacent printing couple. A satellite cylinder normally cooperates with several transfer cylinders of different printing couples. In the case of sheet-fed printing presses, the impression cylinder cooperating with the transfer cylinder of a printing couple is designated as a printing cylinder.

In order to drive the cylinders of a printing couple of a printing press, intermeshing drive gears are assigned to the cylinders. Thus, for example, the plate cylinder, the transfer cylinder as well as the impression cylinder of a printing couple are each assigned at least one drive gear, wherein at least the drive gears of the plate cylinder and the transfer cylinder of a printing couple intermesh. In this case, the meshing of the intermeshing drive gears in this case is affected in principle by backlash.

In order to avoid technical problems during printing, such as so-called “doubling,” there may not be any tooth backlash in effect between the intermeshing drive gears in the direction of force or in the drive direction. The defined abutment of the tooth flanks of the intermeshing drive gears is guaranteed in practice by a strong power consumer at the end of each gear chain. However, because driven cylinders of a printing couple are not just driven by the drive gears, but in fact also by packings like, for example, printing plates and blankets as well as by bearer rings if applicable, it can occur that a braking torque made available by the power consumer is not great enough to guarantee a defined abutment of the tooth flanks in all operating conditions. This can have a negative impact on print quality.

Avoiding tooth backlash between intermeshing drive gears, which are assigned to cylinders of a printing couple of a printing press, by assigning a co-rotating gear to the drive gear of the plate cylinder, which, like the drive gear of the plate cylinder, meshes with the drive gear of the transfer cylinder, is known from German Patent Document No. DE 197 51 117 A1. A leaf spring arrangement extending in the radial direction can be used to exert a force on the drive gear of the plate cylinder as well as on the co-rotating gear in order to pre-stress the co-rotating gear and the drive gear of the plate cylinder in such a manner that the gears rotate in opposite directions. The attainment known from DE 197 51 117 A1 for avoiding tooth backlash between intermeshing drive gears of cylinders of a printing couple of a printing press requires a relatively large amount of construction space in the radial direction. In addition, an axial bearing of the co-rotating gear is required.

The foregoing difficulties are not just encountered with printing couples, but also with other driven components of a printing press such as in the case of the folding unit for example.

Starting herefrom, the present invention is based on the objective of creating a novel driven component of a printing press.

According to the invention, the drive gear of a first rotating element, which meshes with the drive gear of a second rotating element, is assigned a co-rotating gear, which is connected to the drive gear of the first rotating element via at least one spring element or bending element, which extends in the axial direction of the first rotating element, wherein the co-rotating gear can be rotated with respect to the drive gear in such a way in the circumferential direction that a meshing between the two intermeshing drive gears that is affected in principle by backlash can be kept free of backlash.

In the case of the inventive driven component, it is guaranteed that a meshing between intermeshing drive gears that is affected in principle by backlash can be kept free of backlash so that there is no tooth backlash in effect between these drive gears.

The inventive attainment manages with a minimal amount of construction space in the radial direction. In addition, an axial bearing of the co-rotating gear is not required since the axial fastening of the co-rotating gear is handled by the, or each, bending element. The inventive design can be realized simply and cost-effectively. A further advantage is that the inventive attainment is relatively rigid so that the co-rotating gear has to be rotated only relatively slightly with respect to the respective drive gear in order to realize the desired absence of backlash.

The co-rotating gear has an identical meshing geometry as the respective drive gear and intermeshes with the respective other drive gear.

Preferred developments of the invention are yielded from the following description. Without being limited hereto, one exemplary embodiment of the invention is explained in greater detail on the basis of the drawing.

### BRIEF DESCRIPTION OF THE DRAWING

FIG. 1 is a section of a printing unit of a web-fed rotary printing press in the region of two inventive driven components of a printing press that are embodied as printing couples.

### DETAILED DESCRIPTION OF THE DRAWINGS

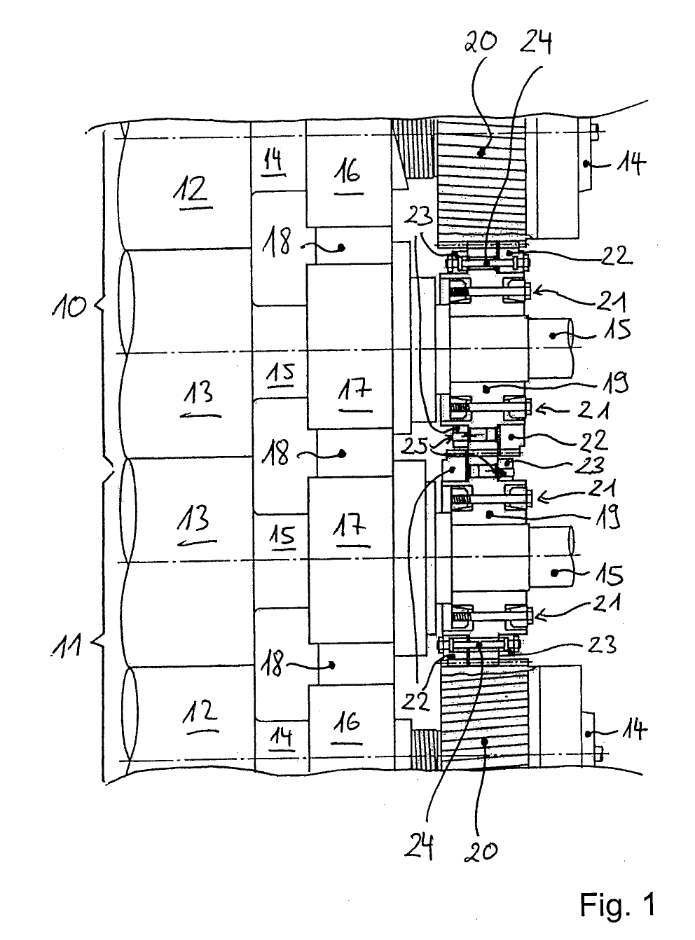

FIG. 1 shows a section of a printing unit of a web-fed printing press in the region of two printing couples 10 and 11, wherein each printing couple 10, 11 has a plate cylinder or engraving cylinder 12 and a transfer cylinder or blanket cylinder 13. In addition to the depicted plate cylinder 12 and the depicted transfer cylinder 13, each printing couple 10, 11 also has an inking system (not shown) as well as preferably a dampening unit (not shown).

In the case of the printing unit in FIG. 1, the two transfer cylinders 13 of the two printing couples 10, 11 roll off each other forming a nip for a to-be-printed printing substrate so that consequently the transfer cylinder 13 of the printing couple 11 forms the impression cylinder for the transfer cylinder 13 of the printing couple 10, and the transfer cylinder 13 of the printing couple 10 forms the impression cylinder for the transfer cylinder of the printing couple 11.

The plate cylinders 12 as well as the transfer cylinders 13 of the printing unit depicted in FIG. 1 are rotatably mounted on their depicted cylinder pins 14 or 15 via bearings 16 or 17 on a side wall 18 of a frame of the printing unit.

On the side of the side wall 18 that is opposite from the cylinders 12, 13, drive gears 19 or 20 are positioned on the cylinder pins 14, 15 of the plate cylinders 12 as well as the transfer cylinders 13. Thus, FIG. 1 shows that drive gears 20 are positioned on the cylinder pins 14 of the plate cylinders 12, and that drive gears 19 are positioned on the cylinder pins 15 of the blanket cylinders 13, wherein the drive gears 19, 20 of each printing couple 10, 11 intermesh respectively. FIG. 1 shows an example of the drive gears 19 of the transfer cylinders 13, that same are fastened on the respective cylinder pin 15 of the transfer cylinder 13 with the aid of clamping elements 21, which provide a torque connection between the respective drive gear and the respective cylinder pin

As already explained, the drive gears 19 and 20 of the plate cylinder 12 and the transfer cylinder 13 intermesh in the area of each printing couple 10, 11. This meshing is affected in principle by backlash. However, in order to avoid printing-related problems, there may not be any tooth backlash in effect. For this purpose, in the depicted exemplary embodiment, each drive gear 19 of a transfer cylinder 13 is assigned a co-rotating gear 22 and preferably an adjusting plate 23. The co-rotating gear 22 has an identical meshing geometry as the drive gear 19 of the transfer cylinder 13, to which the co-rotating gear 22 is assigned. In addition, the co-rotating gear 22, like the drive gear 19 of the transfer cylinder 13, meshes with the drive gear 20 of the plate cylinder 12.

In the area of each printing couple 10, 11, the co-rotating gear 22 that is assigned to the respective drive gear 19 of the respective transfer cylinder 13 is connected via spring elements or bending elements embodied as bending rods 24, and the adjusting plate 23 that is assigned to the respective drive gear 19 is connected to the drive gear 19.

The bending rods 24 are preferably positioned uniformly distributed over the circumference of the drive gear 19, the co-rotating gear 22 and the adjusting plate 23, wherein the bending rods 24 extend in the axial direction and preferably penetrate the adjusting plate 23, the co-rotating gear 22 and the drive gear 19 of the transfer cylinder 13. As a result, the bending elements/bending rods can be designed to be longer, whereby the elasticity/resilience of the connection between the co-rotating gear 22 and the drive gear 19 can be influenced.

According to FIG. 1, the co-rotating gear 22 is screwed together via bending rods 24 with the adjusting plate 23 at a first side of same and the adjusting plate 23 is screwed together with the drive gear 19 on the side facing away from the co-rotating gear 22. The co-rotating gear 22 and the adjusting plate 23 are consequently arranged on the opposing sides of the respective drive gear 19.

By rotating the adjusting plate 23 in the circumferential direction with respect to the respective drive gear 19 of the transfer cylinder 13, the co-rotating gear 22 can be rotated with respect to the drive gear 19 of the respective transfer cylinder 13. Rotating the adjusting plate 23 with respect to the respective drive gear 19 and therefore rotating the co-rotating gear 22 with respect to same takes place in such a way that when, on the one hand, the drive gears 19, 20 and, on the other hand, the co-rotating gear 22 assigned to the drive gear 19 intermesh with the drive gear 20, driving tooth flanks of the two drive gears 19, 20 of the transfer cylinder 13 and the plate cylinder 12 bear against one another and, in addition, non-driving tooth flanks of the co-rotating gear 22 bear against non-driving tooth flanks of the drive gear 20 of the respective plate cylinder 12 of the printing couple 10 or 11. As a result, the meshing between the two intermeshing drive gears 19, 20 of the transfer cylinder 13 and the plate cylinder 12 that is affected in principle by backlash can be kept free of backlash in the area of each printing couple.

In order to rotate the respective adjusting plate 23 with respect to the drive gear 19, the adjusting plate 23 is assigned an eccentric 25.

To facilitate a relative movement between the co-rotating gear 22 and the drive gear 19, a sliding bearing is embodied between the co-rotating gear 22 and the drive gear 19, in particular a plastic sliding bearing, in order to prevent this from rusting in only slightly relative to other moving components.

As already stated, the absence of backlash of the intermeshing drive gears 19, 20 of the transfer cylinders 13 and plate cylinders 12 of the printing couples 10, 11 is provided in that, in the exemplary embodiment in FIG. 1, each drive gear 19 of a transfer cylinder 13 is assigned both a co-rotating gear 22 as well as an adjusting plate 23, which are coupled to one another via bending rods 24. By rotating the adjusting plate 23 in the circumferential direction with respect to the respective drive gear 19, the co-rotating gear 22 can also be rotated with respect to the respective drive gear 19.

The number of bending rods 24 and/or the material for the bending rods 24 and/or the geometric shape of the bending rods 24 as well as the extent of rotating the adjusting plate 23 with respect to the respective drive gear 19 determines when the co-rotating gear 22 assigned to the drive gear 19 of the transfer cylinder 13 meshes with the drive gear 20 of the plate cylinder 12, the tension between the co-rotating gear 22 and the drive gear 19 of the transfer cylinder 13 as well as the tension between the co-rotating gear 22 and the drive gear 20 of the plate cylinder 12 and therefore a deflection of the bending rods 24. As a result, it is possible in a simple and cost-effective way to realize the absence of backlash between the drive gears 19, 20 of the plate cylinder 12 and the transfer cylinder 13.

The inventive design is relatively rigid so that a relative rotation of only a few tenths of a millimeter is sufficient to apply the required tension for the absence of backlash. In an uninstalled state, the gears can be rotated against one another and therefore be preset and afterwards be assembled in a so-called impression-off position. In this impression-off position, the tooth backlash is greater than the rotation to each other. If the cylinders and therefore the gears are subsequently transferred to the impression-on position, i.e., set to a theoretic axis distance, the rotation of the gears to one another is built up and tension between the same is provided.

In the exemplary embodiment depicted in FIG. 1, a drive is assigned to each transfer cylinder 13. The drive gears 19 of the transfer cylinders 13 are consequently driven directly by a drive assigned to the respective transfer cylinder 13.

The drive gears 20 of the plate cylinders 12, on the other hand, are driven indirectly by the drive gear 19 of the transfer cylinder 13 of the respective printing couple 10 or 11. According to FIG. 1, the co-rotating gear 22 and the adjusting plate 23 are consequently assigned to a directly driven drive gear, namely to a directly driven drive gear 19 of the transfer cylinder 13 of the respective printing couple.

In contrast to this, it is also possible for drives to be assigned, not to the transfer cylinders 13, but to the plate cylinders 12. Likewise, it is possible that, in the area of each printing couple, the co-rotating gear and the adjusting plate are not assigned to the directly driven drive gear, but rather to the indirectly driven drive gear of the indirectly driven cylinder.

Making reference to FIG. 1, the invention was described for printing couples of a printing unit of a web-fed printing press in which the transfer cylinders of two adjacent printing couples roll off each other.

In contrast to this, it is also possible for the invention to be used for printing couples of a satellite printing unit comprised of at least one satellite cylinder, which rolls off the transfer cylinders of several printing couples. Likewise, the invention can be used with a printing couple of a sheet-fed printing press.

Making reference to FIG. 1, the invention was described for the preferred application case, in which the driven component of the printing press is embodied as a printing couple. Other application cases are also possible such as in a folding unit for example. The intermeshing drive gears can be assigned not just to cylinders, but also to rollers or other rotating elements of a driven component of a printing press.

List of reference numerals:

10 Printing couple

11 Printing couple

12 Plate cylinder

13 Transfer cylinder

14 Pin

15 Pin

16 Bearing

17 Bearing

18 Side wall

19 Drive gear

20 Drive gear

21 Clamping element

22 Co-rotating gear

23 Adjusting plate

24 Bending rod

25 Eccentric

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A driven component of a printing press, having several rotating elements, wherein at least two rotating elements are assigned to intermeshing drive gears, wherein a drive gear of a first rotating element, which meshes with a drive gear of a second rotating element, is assigned a co-rotating gear, which is connected to the drive gear of the first rotating element via a spring element or bending element, which extends in an axial direction of the first rotating element, and wherein the co-rotating gear is rotatable with respect to the drive gear of the first rotating element in such a way in a circumferential direction that a meshing between the two intermeshing drive gears that is affected in principle by backlash is kept free of backlash.

2. The component according to claim 1, wherein the drive gear of the first rotating element is assigned an adjusting plate in addition to the co-rotating gear, wherein by rotating the adjusting plate in the circumferential direction the co-rotating gear is rotated with respect to the drive gear of the first rotating element in such a way in the circumferential direction that the meshing between the two intermeshing drive gears that is affected in principle by backlash is kept free of backlash.

3. The component according to claim 1, wherein the co-rotating gear that is assigned to the drive gear of the first rotating element has an identical meshing geometry as the drive gear to which the co-rotating gear is assigned, and wherein the co-rotating gear meshes with the drive gear of the second rotating element.

4. The component according to claim 1, wherein a sliding bearing is embodied between the co-rotating gear and the drive gear of the first rotating element to which the co-rotating gear is assigned.

5. The component according to claim 2, wherein the adjusting plate is rotatable via an eccentric in the circumferential direction with respect to the drive gear of the first rotating element to which the adjusting plate is assigned.

6. The component according to claim 2, wherein by rotating the adjusting plate with respect to the drive gear of the first rotating element to which the adjusting plate is assigned, the co-rotating gear that is assigned to the drive gear is rotated with respect to the drive gear in such a way that driving tooth flanks of the drive gear of the first rotating element bear against driven tooth flanks of the drive gear of the second rotating element, and wherein non-driving tooth flanks of the co-rotating gear bear against non-driven tooth flanks of the drive gear of the second rotating element.

7. The component according to claim 2, wherein several bending elements are uniformly distributed over a circumference of the co-rotating gear which connect the co-rotating gear and the adjusting plate to the drive gear of the first rotating element.

8. The component according to claim 7, wherein a number and/or a material and/or a geometric shape of the bending elements and the rotating of the adjusting plate with respect to the drive gear determines a tension between the adjusting plate and the drive gear and a deflection of the bending elements.

9. The component according to claim 2, wherein the component is embodied as a printing couple having a plate cylinder, a transfer cylinder, an inking system as well as a dampening unit, wherein an impression cylinder cooperates with the transfer cylinder forming a nip through which a to-be-printed printing substrate is conveyable, wherein at least the plate cylinder and the transfer cylinder are assigned the intermeshing drive gears, wherein either the drive gear of the transfer cylinder or the drive gear of the plate cylinder is assigned the co-rotating gear and the adjusting plate, which are connected to the respective drive gear via the bending element, which extends in the axial direction through the respective drive gear as well as through the co-rotating gear and the adjusting plate, and wherein by rotating the adjusting plate in the circumferential direction with respect to the respective drive gear, the co-rotating gear is rotated with respect to the respective drive gear in such a way in the circumferential direction that the meshing between the two intermeshing drive gears of the plate cylinder and the transfer cylinder that is affected in principle by backlash is kept free of backlash.

10. The component according to claim 9, wherein the drive gear of the transfer cylinder is driven directly by a drive assigned to the transfer cylinder and the drive gear of the plate cylinder is driven indirectly by the drive gear of the transfer cylinder, and wherein the co-rotating gear and the adjusting plate are assigned to the drive gear of the directly driven transfer cylinder.

11. The component according to claim 9, wherein the drive gear of the plate cylinder is driven directly by a drive assigned to the plate cylinder and the drive gear of the transfer cylinder is driven indirectly by the drive gear of the plate cylinder, and wherein the co-rotating gear and the adjusting plate are assigned to the drive gear of the directly driven plate cylinder.

12. The component according to claim 9, wherein the drive gear of the transfer cylinder is driven directly by a drive assigned to the transfer cylinder and the drive gear of the plate cylinder is driven indirectly by the drive gear of the transfer cylinder, and wherein the co-rotating gear and the adjusting plate are assigned to the drive gear of the indirectly driven plate cylinder.

13. The component according to claim 9, wherein the drive gear of the plate cylinder is driven directly by a drive assigned to the plate cylinder and the drive gear of the transfer cylinder is driven indirectly by the drive gear of the plate cylinder, and wherein the co-rotating gear and the adjusting plate are assigned to the drive gear of the indirectly driven transfer cylinder.

14. A printing press, comprising:
a first rotating element with a first drive gear;
a second rotating element with a second drive gear, wherein a co-rotating gear is connected to the second drive gear via a bending element which extends in an axial direction of the second rotating element, and wherein the co-rotating gear is rotatable with respect to the second drive gear in a circumferential direction;
and wherein the second drive gear and the co-rotating gear are both directly coupled to the first drive gear.

15. The printing press according to claim 14, wherein the first rotating element is a plate cylinder and wherein the second rotating element is a transfer cylinder.

16. The printing press according to claim 14, wherein the second drive gear is driven by a drive and wherein the first drive gear is driven by the second drive gear.

17. The printing press according to claim 14, wherein the bending element is deflected when the co-rotating gear is rotated with respect to the second drive gear in the circumferential direction.

18. The printing press according to claim 14, wherein the co-rotating gear is rotatable with respect to the second drive gear in a circumferential direction less than one millimeter.

19. The printing press according to claim 14, wherein the second drive gear and the co-rotating gear have an identical tooth geometry.

20. The printing press according to claim 14, wherein driving tooth flanks of the first drive gear and the second drive gear bear against one another and wherein non-driving tooth flanks of the co-rotating gear and the first drive gear bear against one another.
